(19) United States
(12) Patent Application Publication
(10) Pub. No.: US 2018/0053239 A1
(43) Pub. Date: Feb. 22, 2018

(54) Shopping Mall Guiding System Based On Internet Of Things And Method Thereof

(71) Applicants: Inventec (Pudong) Technology Corporation, Shanghai (CN); Inventec Corporation, Taipei City (TW)

(72) Inventor: Xiao Qian Li, Shanghai (CA)

(21) Appl. No.: 15/622,773

(22) Filed: Jun. 14, 2017

(30) Foreign Application Priority Data
Aug. 22, 2016 (CN) 201610701400.4

(51) Int. Cl. G06Q 30/06; G06F 17/30; G06Q 20/32; G06Q 30/02; G01C 21/20

(52) U.S. Cl. CPC G06Q 30/0633; G06F 17/30312; G01C 21/206; G06Q 30/0267; G06Q 30/0643; G06Q 20/3224

(57) ABSTRACT

The present disclosure illustrates a shopping mall guiding system based on Internet of Things (IoT) and a method thereof is disclosed. Through IoT, shelves are positioned and product displaying messages thereof are transmitted. A server provides a shopping interface according to the product displaying messages, and after a mobile device logs into the shopping interface and creates an order list, the servers sieves out the shelves according to the order list and the product displaying messages and then generates a shopping route, a map and a product position message for displaying and guiding shopping. As a result, the system and method of the present disclosure may be helpful to improve the shopping convenience.

### CROSS-REFERENCE TO RELATED APPLICATION

This application claims the benefit of Chinese Patent Application No. 201610701400.4, filed Aug. 22, 2016.

### BACKGROUND OF THE INVENTION

### 1. Field of the Invention

The present disclosure relates to a shopping mall guiding technology, and more particularly to a shopping mall guiding system which is able to check presence of a target product based on Internet-of-Things and then generate a shopping route, and a method thereof.

### 2. Description of the Related Art

In recent years, while Internet of Things (IoT) is developed and popularized rapidly, various applications based on IoT are widely implemented in many fields, and the application in a shopping mall to instantly sense displayed products attracts the most attention.

In general, because of having a larger area and displaying a large quantity of products, a conventional shopping mall usually uses an inventory system for management; however, the management using the inventory system is unable to response that the displayed product is not on a shelf and also not sold yet, for example, a client takes a product from the shelf and places the product in a shopping cart, but does not check out yet; in this case, the product is misjudged to be on the shelf, and the misjudgment may impact clerk's replenishment efficiency, and what is more serious is that, for other client, there is no product to buy. As a result, the conventional management using the inventory system may cause a problem of poor shopping convenience.

For this reason, a manufacturer develops technology to instantly monitor import and export of displayed products based on IoT. This technology may be helpful to improve the replenishment efficiency to prevent the client from the situation that there is no product to buy, but the shopping mall usually has a large area and displays a great quantity of products, client may not find desired products quickly even there are product signs. Hence, aforementioned technology is still unable to solve the problem of poor shopping convenience.

As a result, what is need is to develop a shopping guiding system to solve the problem of poor shopping convenience.

### SUMMARY OF THE INVENTION

In order to solve above-mentioned problem, the present disclosure is to provide a shopping mall guiding system based on IoT. The system includes a database, at least one electronic billboard, at least one shelf, a mobile device, and a server. The database is configured to store at least one client message which each includes client data and at least one purchase history. The at least one electronic billboard is configured to continuously receive information of at least one predetermined promotional product and an advertisement link for display on a display device. Each of the at least one shelf is positioned through IoT and configured to transmit and instantly update a current product displaying message thereof through IoT. The mobile device is configured to log into a shopping interface according to client data to create an order list, and receive a shopping route, a map and a product position message for display. The server is configured to continuously transmit the information of the at least one predetermined promotional product and the advertisement link to the at least one electronic billboard, and receive the current product displaying message of the at least one shelf to provide the corresponding shopping interface, and sieve out the at least one shelf according to the order list created by the mobile device and the current product displaying message of the at least one shelf, so as to generate and transmit the shopping route, the map and the product position message to the mobile device, and use the order list created by the mobile device as the purchase history corresponding to the client message and store the order list in the database.

In order to solve above-mentioned problem, the present disclosure is further to provide a shopping mall guiding method based on IoT. The method is applied to network environment including a database, at least one electronic billboard, at least one shelf, a mobile device and a server, and the method includes following steps: in the database, storing at least one client message which each includes client data and at least one purchase history; continuously transmitting information of at least one predetermined promotional product and an advertisement link from the server to the electronic billboard, and continuously displaying the information of the at least one predetermined promotional product and the advertisement link by a display device of the electronic billboard; positioning the at least one shelf through IoT, and transmitting and instantly updating a current product displaying message of the at least one shelf through IoT; in the server, receiving the current product displaying message of the at least one shelf and providing a shopping interface corresponding to the current product displaying message; in the mobile device, logging into the shopping interface according to the client data, and creating an order list corresponding to the client data; and in the server, sieving out the at least one shelf according to the order list created by the mobile device and the current product displaying message of the at least one shelf, to generate a shopping route, a map, and a product position message, and transmitting the shopping route, the map, and the product position message to the mobile device for display, and storing the order list created by the mobile device in the database as the purchase history.

According to above description, the difference between the present disclosure and the conventional technology is that, in the system and method of the present disclosure, the shelves are positioned through IoT and the product displaying messages of the shelves are transmitted through IoT, and the server provides the shopping interface according to the product displaying messages, and after the mobile device logs into the shopping interface and creates the order list, the server sieves out the shelf according to the order list and the product displaying messages to generate the shopping route, the map and the product position message for guiding user to shop.

By using above technical means, the technical effect of improving shopping convenience may be achieved.

### BRIEF DESCRIPTION OF THE DRAWINGS

The structure, operating principle and effects of the present disclosure will be described in detail by way of various embodiments which are illustrated in the accompanying drawings.

FIG. 1 is a block diagram of a shopping mall guiding system based on Internet-of-Things (IoT), in accordance with the present disclosure.

FIG. 2 is a flowchart showing the steps in an operation of a shopping mall guiding method based on IoT, in accordance with the present disclosure.

FIG. 3 is a schematic view of a shelf and an instantly-updated current product displaying message of the present disclosure.

FIG. 4 is a schematic view of a shopping route, a map and a product position message of the present disclosure.

### DETAILED DESCRIPTION OF THE PREFERRED EMBODIMENTS

The following embodiments of the present invention are herein described in detail with reference to the accompanying drawings. These drawings show specific examples of the embodiments of the present invention. It is to be understood that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be understood that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present invention. As used herein, the term “or” includes any and all combinations of one or more of the associated listed items.

Before illustration for the shopping mall guiding system based on IoT and the method thereof of the present disclosure, environment where the system and method of the present disclosure are applied is described first. A shelf of the present disclosure has an IoT function to obtain a position of the shelf, transmit a product displaying message and instantly update the product displaying message. In actual implementation, a database, an electronic billboard, the shelf, a mobile device and a server are in communication with each other through network, and the database may be installed in the server.

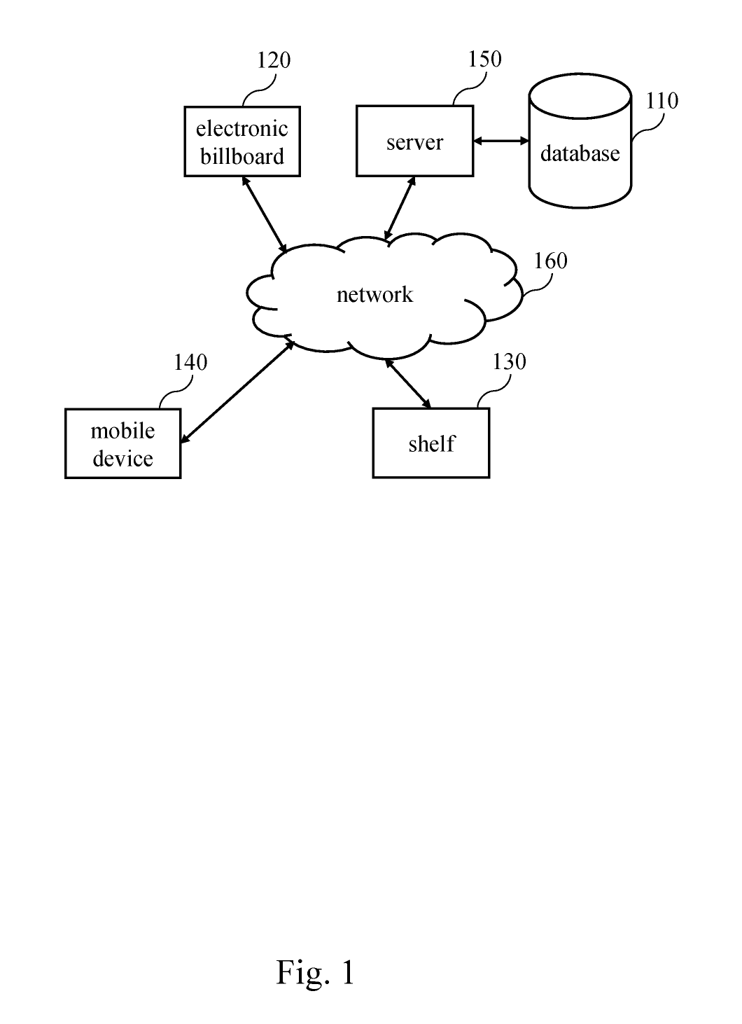

The following describes a shopping mall guiding system based on IoT and the method thereof of the present disclosure, with reference to the accompanying drawings. Please refer to FIG. 1, which is a block diagram of the shopping mall guiding system of the present disclosure. The shopping mall guiding system includes a database 110, an electronic billboard 120, a shelf 130, a mobile device 140 and a server 150. The database 110 is configured to store client messages, and each client message includes client data and purchase history. In actual implementation, the database 110 may be linked with the server 150 through network 160, or may be disposed in the server 150, so that the database 110 may receive and store the purchase history generated by the server 150. The database 110 may be a relational database or a NoSQL, and use a hard disk, a recordable optical disk, a flash memory or a RAM memory as a storage carrier. Furthermore, each client message may include purchase preference. The server 150 may analyze the purchase history corresponding to the same client message by time period, such as a week, a month, a quarter, a year and so on, to generate the purchase preference corresponding to the client message and store the generated purchase preference in the database 110. For example, if the purchase history corresponding to the same client message records a pack of cigarettes every day, the server 150 may determine the cigarette to be the purchase preference which is then stored in the database 110.

The electronic billboard 120 is configured to continuously receive information of promotional products and an advertisement link and then continuously display the information of promotional products and the advertisement link on a display device. Preferably, the display device may be a LCD displayer, a plasma displayer and so on. The manner of displaying various promotional products may be implemented by displaying the promotional products in a loop with various display effect, such as fade-in-and-fade-out effect, flip-book effect, rolling effect, slideshow effect and so on. The advertisement link is a hyperlink which may be displayed in the form of text or QR Code, and the user holding the mobile device 140 may click or scan the hyperlink to open a web page corresponding thereto to browse the promotional product, advertisement or electronic publication published by the shopping mall. In actual implementation, the electronic billboard 120 may receive the information of the promotional products and the advertisement link through the network 160, and display the information of the promotional products and the advertisement link on the display device.

The shelf 130 is positioned through IoT (that is, a position of the shelf may be obtained through IoT), and each shelf 130 may instantly update a current product displaying message which is transmitted through IoT. In actual implementation, IoT may include RFID technology, and each product displayed on the shelf 130 has a RFID tag corresponding thereto, so that the shelf 130 may instantly check presence of each product and the number of the product to generate the current product displaying message. The current product displaying message may include information of the displayed product, such as a product name and an expiration date. After the shelf 130 updates the product displaying message, the updated product displaying message is transmitted to the server 150 for further process which will be described in detail later.

The mobile device 140 is configured to log into the shopping interface according to the client data (such as an account and a password), to create the order list corresponding to the client data, and may be used to receive and display a shopping route, a map and a product position message received from the server 150. In actual implementation, the user may operate the mobile device 140 to select at least one product of a product list provided by the shopping interface, to generate the order list. Preferably, the order list may include the number and a name of the product which the user wants to order. Furthermore, the mobile device 140 may overlap the shopping route, the map and the product position message as vector layers, and display overlapped vector layers on a screen thereof. Preferably, the map is the most bottom layer to avoid covering the shopping route and the product position message.

The server 150 is configured to continuously transmit the information of the promotional products and the advertisement link to the electronic billboard 120, and the electronic billboard 120 may continuously display the information of the promotional product and the advertisement link. In actual implementation, the server 150 may sieve out the promotional product from all displayed products, and a difference between an expiration date of the promotional product and the current date is within an allowable range, such as one day, two days, three day and so on, or the same day. In other words, from all displayed products, the server 150 may find expiring products as the promotional products. Furthermore, the server 150 may receive the current product displaying message of each shelf 130 to provide the shopping interface for the logged-in mobile device 140 to perform shopping operation, as a result, sold-out product is not displayed on the shopping interface. After the mobile device 140 creates the order list, the server 150 searches at least one shelf 130 having the ordered product according to the order list and the current product displaying messages of the shelves 130, and then generates the shopping route, the map and the product position message according to positions of the targeted shelf 130, and transmits the shopping route, the map and the product position message to the mobile device 140 for display. For example, suppose that there are two shelves 130, and the current product displaying message of the first shelf is “shelf one; product A; quantity: 5”, and the current product displaying message of the second shelf is “shelf two; product B; quantity: 3”. If the order list created by the mobile device 140 is “product A, quantity 1; product B, quantity 1”, the server 150 generates the shopping route according to the order list and product displaying messages of all shelves 130. The order list of the mobile device 140 includes the product A and the product B which are separately displayed on the first shelf and the second shelf, so the server 150 may detect current positions of the mobile device 140, the first shelf and the second shelf to calculate the shopping route, for example, the server 150 calculates the shortest route reaching the first shelf and the second shelf as the shopping route.

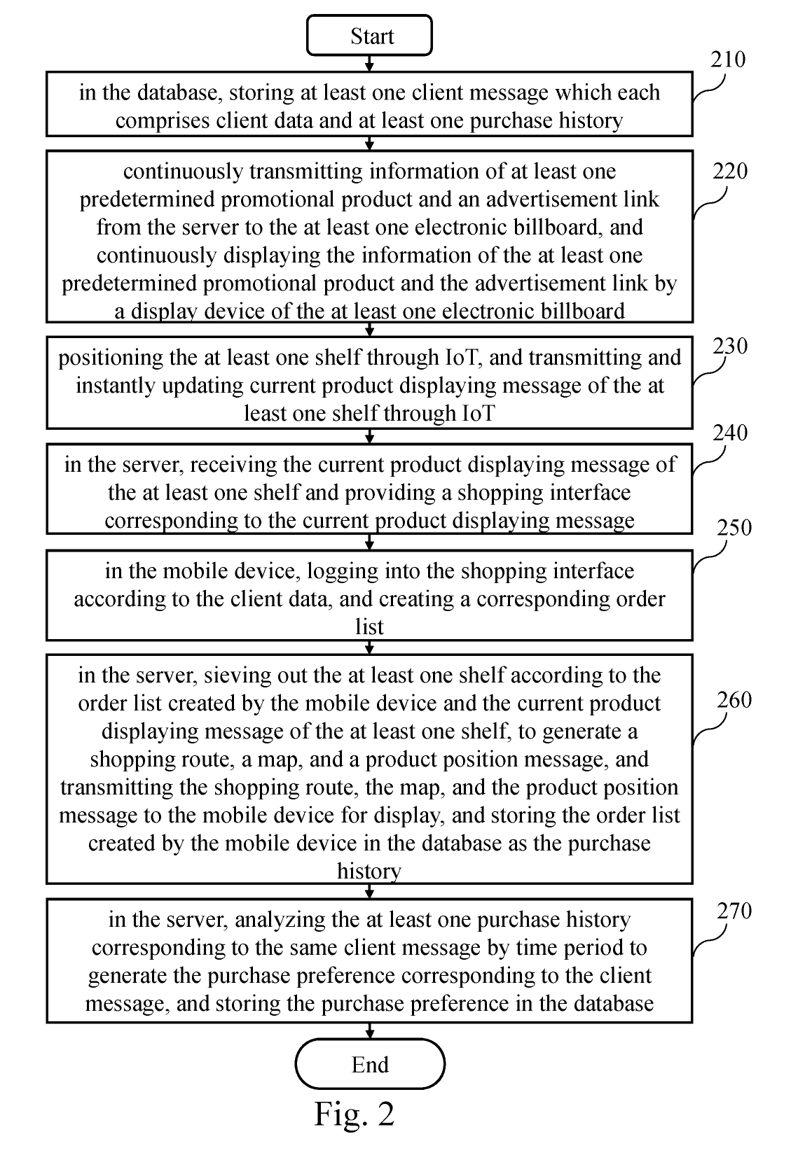

The following refers to FIG. 2, which is a flowchart showing the steps in an operation of the shopping mall guiding method based on IoT, in accordance with the present disclosure. The shopping mall guiding method is applied to network environment including the database 110, the electronic billboard 120, the shelf 130, the mobile device 140 and the server 150. The shopping mall guiding method includes following steps. In a step 210, the database 110 stores the client message, and each client message includes the client data and the purchase history. In a step 220, the server 150 continuously transmits the information of predetermined promotional products and the advertisement link which are then displayed on the display device of the electronic billboard 120 continuously. In a step 230, each shelf 130 is positioned by IoT, and the current product displaying message of each shelf 130 is transmitted and instantly updated through IoT. In a step 240, the server 150 receives the current product displaying message of each shelf 130 and provides the shopping interface. In a step 250, the mobile device 140 logs into the shopping interface according to the client data, to create the order list corresponding to the client data. In a step 260, the server 150 sieves out the shelf 130 according to the order list created by the mobile device 140 and the current product displaying messages of the shelves 130, to generate the shopping route, the map and the product position message and transmits the shopping route, the map and the product position message to the mobile device 140 for display, and the order list created by the mobile device 140 is stored in the database 110 as the purchase history. Through aforementioned steps, the shelves 130 may be positioned and the product displaying messages may be transmitted through IoT, and the server 150 provides the shopping interface according to the product displaying messages; after the mobile device 140 logs into the shopping interface and creates the order list, the server 150 sieves out corresponding shelf according to the order list and the product displaying messages to generate the shopping route, the map and the product position message for display, thereby guiding the user for shopping.

It is to be noted that the method may include a step 270 after the step 260. In the step 270, the server 150 analyzes the purchase history corresponding to the same client message by time period, to generate purchase preference corresponding to the client and store the purchase preference in the database 110. As a result, a personalization shopping interface may be provided according to the purchase preference. For example, the product meeting the purchase preference may be displayed on a home page of the shopping interface, or be enlarged or highlighted on the shopping interface.

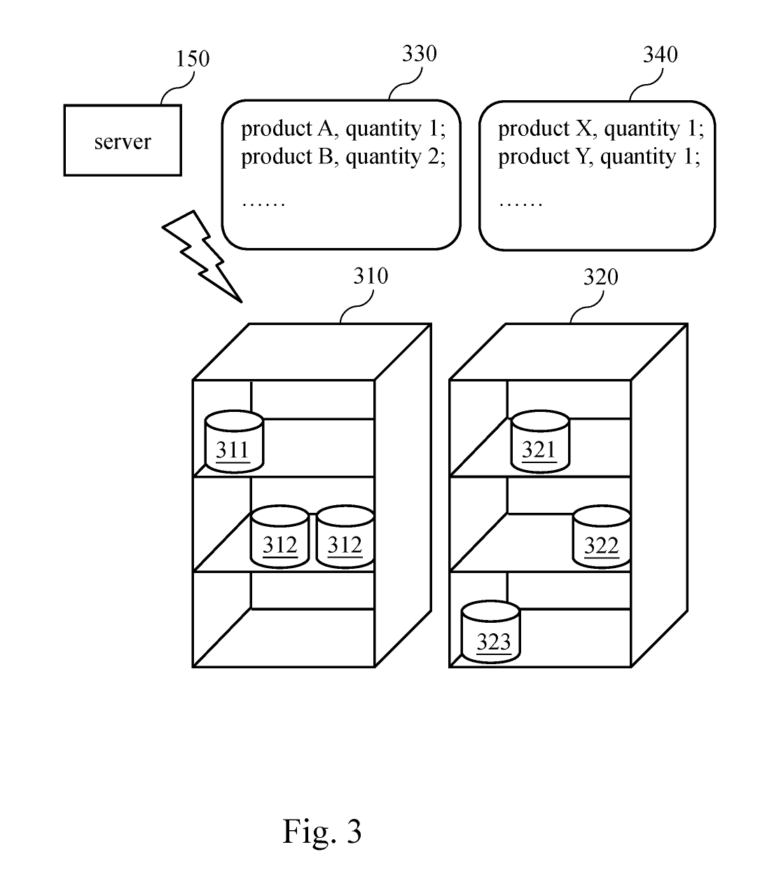

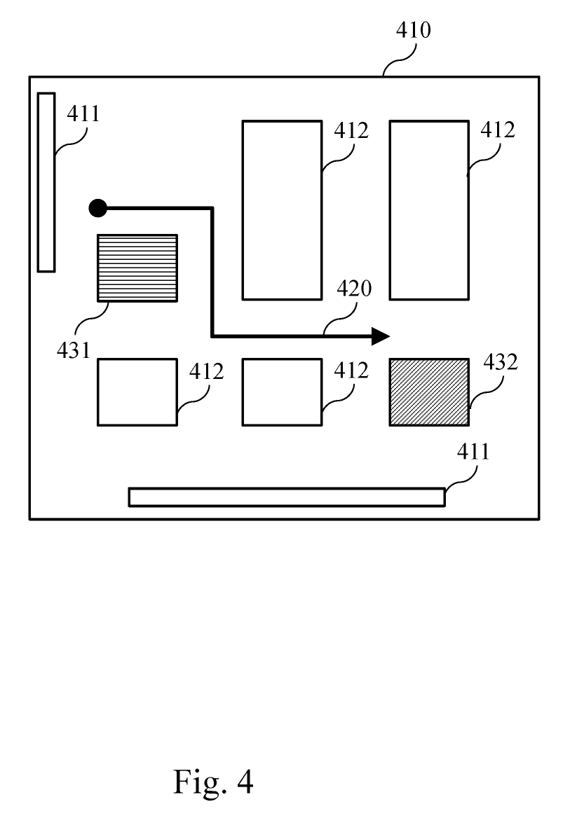

The following refers to an embodiment in cooperation with FIGS. 3 and 4 for illustration of the present disclosure. Please refer to FIG. 3, which is a schematic view of the shelf and instantly-updated current product displaying message of the present disclosure. The shelves 310 and 320 are configured to display products 311, 312, and 321˜323, and each of the shelves 310 and 320 is positioned by IoT, and the current product displaying messages 330 and 340 of the shelves 310 and 320 is updated instantly through IoT. The updated product displaying messages 330 and 340 are transmitted to the server 150. The server 150 may generate the shopping interface according to the product displaying messages 330 and 340 of the shelves 310 and 320, thereby preventing the shopping interface from displaying the sold-out product. After the mobile device 140 logs into the shopping interface, the product displayed on the shelves 310 and 320 may be browsed on the shopping interface, and the user may perform shopping operation to create the order list. In actual implementation, the current product displaying messages 330 and 340 may be instantly updated by RFID, for example, RFID tags may be separately disposed on the displayed products 311, 312, and 321˜323 in advance, and readers corresponding to the RFID tags are separately disposed on the shelves 310 and 320. The readers are configured to continuously emit RF signals to read the RFID tags of the displayed products 311, 312 and 321˜323, so as to obtain messages. When the client takes the displayed product 311, the reader of the shelf 310 may detect absence of the RFID tag of the displayed product 311, so that the current product displaying message 320 is then updated, for example, the message of “product A, quantity 1” may be deleted, or modified as “product A, quantity 0”.

Please refer to FIG. 4, which is a schematic view of the shopping route, the map and the product position message of the present disclosure. According to aforementioned content, the server 150 sieves out a target shelf 130 from all shelves 130 according to the order list created by the mobile device 140 and the current product displaying messages of the shelves 130, to generate the shopping route, the map and the product position message, and transmits the shopping route, the map and the product position message to the mobile device 140 for display. For example, suppose that the order list includes the product A and the product B, and current product displaying message of the shelf A includes the product A, and the current product displaying message of the shelf B includes the product B; the server 150 may sieve out the shelves A and B from all shelves 130, and then calculate a shortest route among the mobile device 140, the shelves A and B according to a current position of the mobile device 140 and the current positions of the shelves A and B, and use the shortest route as the shopping route 420 which is displayed in cooperation with the map 410, and the product position messages 431 and 432. In actual implementation, the map 410 may be a shopping mall floor plan in cooperation with electronic billboard icons 411 and the shelf icons 412 which are displayed on the shopping mall floor plan at corresponding positions. The product position messages 431 and 432 may be displayed correspondingly to display positions of the shelves including the products which the user wants to purchase; for example, as shown in FIG. 4, the product position messages 431 and 432 are displayed by halftone; in other embodiment, the product position messages 431 and 432 may be displayed by text of product name, quantity, or a combination thereof; in other embodiment, the product position messages 431 and 432 may be displayed by color areas.

Furthermore, in actual implementation, the shopping route 420, the map 410 and the product position messages 431 and 432 generated by the server 150 may be transmitted to the electronic billboard 120, which is nearest to the mobile device 140, for display. For example, the electronic billboard icons 411 at upper left corner and bottom of FIG. 4 respectively indicate the two electronic billboards 120 existing at the shopping mall, and the positions of the two electronic billboards 120 and the shelves 130 may be determined through IoT. As a result, when the mobile device 140 is located at the area of the upper left corner of the map, the shopping route 420, the map 410 and the product position messages 431 and 432 may be displayed on the electronic billboard 120 located at the area of the upper left corner of the map, so that the shopper may easily browse the shopping route displayed on the nearby electronic billboard 120 without watching the relatively small screen of the mobile device 140.

To summarize, the difference between the present disclosure and the conventional technology is that, in the system and method of the present disclosure, the shelves are positioned through IoT and the product displaying messages of the shelves are transmitted through IoT, and the server provides the shopping interface according to the product displaying messages, and after the mobile device logs into the shopping interface and creates the order list, the server sieves out the shelf according to the order list and the product displaying messages to generate the shopping route, the map and the product position message to guide user for shopping. By using above technical means, the conventional technology problem may be solved, and the technical effect of improving shopping convenience may be achieved.

The present disclosure disclosed herein has been described by means of specific embodiments. However, numerous modifications, variations and enhancements can be made thereto by those skilled in the art without departing from the spirit and scope of the invention set forth in the claims.

What is claimed is:

1. A shopping mall guiding system based on Internet of Thing (IoT), comprising:
a database configured to store at least one client message which each comprises client data and at least one purchase history;
at least one electronic billboard configured to continuously receive information of at least one predetermined promotional product and an advertisement link for display on a display device;
at least one shelf, each of the at least one shelf being positioned through IoT and configured to transmit and instantly update current product displaying message thereof through IoT;
a mobile device configured to log into a shopping interface according to client data to create an order list, and receive a shopping route, a map and a product position message for display; and
a server configured to continuously transmit the information of the at least one predetermined promotional product and the advertisement link to the at least one electronic billboard, and receive the current product displaying message of at least one shelf to provide the corresponding shopping interface, and sieve out the at least one shelf according to the order list created by the mobile device and the current product displaying message of the at least one shelf, so as to generate and transmit the shopping route, the map and the product position message to the mobile device, and use the order list created by the mobile device as the purchase history corresponding to the client message and store the order list in the database.

2. The shopping mall guiding system of according to claim 1, wherein each of the at least one client message further comprises a purchase preference, and the server analyzes the at least one purchase history corresponding to the same client message by time period, to generate the purchase preference corresponding to the same client message, and store the purchase preference in the database.

3. The shopping mall guiding system of according to claim 1, wherein the shopping route, the map and the product position message generated by the server are transmitted to and displayed on the electronic billboard nearest to the mobile device.

4. The shopping mall guiding system according to claim 1, wherein the product displaying message comprises information of at least one displayed product, and the information of at least one displayed product comprises a product name and an expiration date, and the server sieves out the at least one predetermined displayed product from the displayed products, and a difference between the expiration date of the at least one predetermined displayed product and the current date is within an allowable range.

5. The shopping mall guiding system according to claim 1, wherein the advertisement link is displayed in the form of text, QR Code or a combination thereof.

6. A shopping mall guiding method based on IoT, applied to network environment comprising a database, at least one electronic billboard, at least one shelf, a mobile device and a server, and the shopping mall guiding method comprising:
in the database, storing at least one client message which each comprises client data and at least one purchase history;
continuously transmitting information of at least one predetermined promotional product and an advertisement link from the server to the at least one electronic billboard, and continuously displaying the information of the at least one predetermined promotional product and the advertisement link by a display device of the at least one electronic billboard;
positioning the at least one shelf through IoT, and transmitting and instantly updating current product displaying message of the at least one shelf through IoT;
in the server, receiving the current product displaying message of the at least one shelf and providing a shopping interface corresponding to the current product displaying message;
in the mobile device, logging into the shopping interface according to the client data, and creating an order list corresponding to the client data; and
in the server, sieving out the at least one shelf according to the order list created by the mobile device and the current product displaying message of the at least one shelf, to generate a shopping route, a map, and a product position message, and transmitting the shopping route, the map, and the product position message to the mobile device for display, and storing the order list created by the mobile device in the database as the purchase history.

7. The shopping mall guiding method according to claim 6, further comprising:
in the server, analyzing the at least one purchase history corresponding to the same client message by time period to generate the purchase preference corresponding to the client message, and storing the purchase preference in the database.

8. The shopping mall guiding method according to claim 6, wherein the server transmits the shopping route, the map and the product position message to the electronic billboard, which is nearest to the mobile device, for display.

9. The shopping mall guiding method according to claim 6, wherein the product displaying message comprises information of at least one displayed product, and the information of each of the at least one displayed product comprises a product name and an expiration date, and the server sieves out the at least one predetermined promotional product from all of the displayed products, and a difference between the predetermined promotional product and the current date is within an allowable range.

10. The shopping mall guiding method according to claim 6, wherein the advertisement link is displayed in the form of text, QR code, or a combination thereof.
